(19) United States
(12) Patent Application Publication
(10) Pub. No.: US 2014/0208239 A1
(43) Pub. Date: Jul. 24, 2014

(54) GRAPHICAL AGGREGATION OF VIRTUALIZED NETWORK COMMUNICATION

(71) Applicant: MyRooms, Inc., North Ogden, UT (US)

(72) Inventors: Jeremiah Timberline Barker, North Ogden, UT (US); Benjamin Humphrey, Farmington, UT (US); Kory Fluckiger, North Salt Lake, UT (US); Matthew Lee Barker, Harrisville, UT (US)

(73) Assignee: MyRooms, Inc., North Ogden, UT (US)

(21) Appl. No.: 14/163,973

(22) Filed: Jan. 24, 2014

Related U.S. Application Data
(60) Provisional application No. 61/756,457, filed on Jan. 24, 2013.
(60) Provisional application No. 61/898,216, filed on Oct. 31, 2013.

(51) Int. Cl. G06F 3/0481; G06F 15/173

(52) U.S. Cl. CPC G06F 3/04815; G06F 15/17306
USPC 715/757

(57) ABSTRACT

Techniques are described for aggregating information from multiple network-accessible service providers (such as multiple social networking service providers) using virtual objects to represent information, media and services in a plurality of rendered virtual environments, each of which may be associated with one or more users of the multiple service providers. A virtual environment associated with one or more particular users may be presented as any of a variety of internal or external spaces. Users may be represented in the room by virtual avatars, which may move or otherwise operate within one or more of the provided virtual environments. Virtual environments, virtual objects and avatars may be displayed as two- or three-dimensional.

### BACKGROUND

The present disclosure relates to an improved data processing system and, in particular, to methods, systems, and apparatuses for enabling creation of virtual environments in which virtual objects and other interface elements may be utilized to perform a variety of interactions between computing systems associated with various entities.

### SUMMARY

As the Internet and other online access to information continue to grow, users are increasingly presented with an overabundance of available information content without effective means to manage it (e.g., to identify content that is relevant, accurate and enjoyable), or to identify users who create content that has desired attributes. One particular example of an increasing source of content and information relates to users of social networking services or other service providers. Another particular example of an increasing source of content relates to merchants that make items (e.g., products, services, information, etc.) available to customers for purchase, rent, lease, license, trade, evaluation, sampling, subscription, etc., such as via the World Wide Web (“the Web”). In certain situations, users may find it beneficial to interact with such service providers or merchants using virtual environments and virtual objects to represent and encapsulate collections of products, services, information, and other users.

A computer-implemented method for aggregating social service information as described herein may be summarized as including receiving, by one or more computing systems configured to provide a social network service aggregation system, first social network data relating to a first user from a first social network service; receiving, by the one or more configured computing systems, second social network data relating to the first user from a second social network service; displaying, by the one or more configured computing systems, a first virtual object representative of the first social network data within a virtual environment associated with the first user; and displaying, by the one or more configured computing systems and concurrently with the displaying of the first virtual object, a second virtual object representative of the second social network data within the virtual environment associated with the first user.

In certain embodiments, the one or more configured computing systems may be associated with the first user, and the receiving of the first social network data and second social network data may be performed locally with respect to the first user. For at least one of the first and second virtual objects, displaying the virtual object may include displaying the virtual object as a three-dimensional virtual object. The virtual environment associated with the first user may be a three-dimensional environment.

In certain embodiments, the displaying of the first and second virtual objects may include displaying the virtual objects to a distinct second user, and the computer-implemented method may further include receiving an indication of a request from the distinct second user to access at least some of the first social network data. The indicated request may be based at least in part on one or more interactions of the distinct second user with the first virtual object. The computer-implemented method may still further include displaying, based at least in part on the received request from the second user, at least a portion of the first social network data to the distinct second user.

In certain embodiments, the computer-implemented method may further include receiving an indication of a request from the first user to access at least some of the first social network data. The indicated request may be based at least in part on one or more interactions of the first user with the first virtual object, and may be further based at least in part on the receiving of the indicated request. The computer-implemented method may further include displaying to the first user at least a portion of the first social network data.

In at least some embodiments, the computer-implemented method may further include receiving an indication of user-generated data from the first user and, based at least in part on the indicated user-generated data, providing the indicated user-generated data to (a) one or more remote servers associated with the first social network service and (b) one or more distinct other remote servers associated with the second social network service. The method may still further include receiving from the first user an indication that the first user has selected the first social network service and the second social network service. The providing of the user-generated data may be further based in part on receiving the indicated selections from the first user. The user-generated data may include at least one of a group of information provided by the first user that includes text, video, graphics, and images. The method may still further include sending the user-generated data to one or more of a plurality of other users of the social network service aggregation system, and the sending of the user-generated data may be based at least in part on receiving an indication that a distinct second user has selected to send the user-generated data to the one or more other users.

In certain embodiments, the computer-implemented method may further include providing one or more rewards to the first user, the providing of the one or more rewards including receiving activity information indicative of one or more user activities of the user; and providing the one or more rewards to the first user based at least in part on the received activity information. The receiving of the first social network data may be based at least in part on an authorization by the first user for the social networking aggregator application to access a profile of the first user within the first social network, and the activity information may specify a quantity of other users associated with the profile of the first user within the first social network. The activity information may specify one or more of a group that includes a length of user session time, a frequency of user log in sessions, and a quantity of social events. The provided rewards may include one or more units of a virtual currency. The method may further include receiving a request from the first user to exchange one or more units of the virtual currency for one or more virtual objects and, based at least in part on receiving the request, associating the one or more virtual objects with the virtual environment of the first user.

In at least some embodiments, the displaying of the first virtual object may include displaying the first virtual object to a distinct second user. The method may further include receiving an indication of one or more interactions of the second user with the first virtual object and, based at least in part on the one or more interactions of the second user, associating a copy of the first virtual object with a distinct second virtual environment associated with the second user. The associating of the copy of the first virtual object may include displaying the copy of the first virtual object within the distinct second virtual environment. The one or more interactions of the second user may include requesting a copy of the first virtual object in exchange for one or more units of a virtual currency. The method may further include maintaining an association between the first virtual object and the copy of the first virtual object, such that future changes to the first virtual object are propagated to the copy of the first virtual object.

A second computer-implemented method described herein may be summarized as including displaying to a first user, by one or more configured computing systems, social networking information from a second user, the displaying of the social networking information being performed concurrently with displaying to the first user a virtual environment associated with the first user; providing, by the one or more configured computing systems, one or more user-selectable interface elements to the first user, each of the user-selectable interface elements corresponding to a distinct reaction of a graphical avatar; receiving, by the one or more configured computing systems, an indication of a selection by the first user of at least one of the one or more user-selectable interface elements; and displaying to the second user, by the one or more configured computing systems, an avatar animation that includes the graphical avatar expressing the distinct reaction corresponding to the at least one interface element selected by the first user.

In certain embodiments, the second computer-implemented method may further include providing unique origination information to the second user corresponding to the avatar animation, the unique origination information including a web service link for the second user to view the avatar animation.

In at least some embodiments, the second computer-implemented method may still further include providing an indication to the second user that the avatar animation reflects a reaction by the first user to the social networking information from the second user.

A third computer-implemented method described herein may be summarized as including displaying, by one or more configured computing systems, a first virtual environment associated with a first user on a computing system of a second user, the first virtual environment including a virtual object selected by the first user for display in the first virtual environment; and, based at least in part on a selection by the second user of the virtual object in the first virtual environment: (a) displaying, by the one or more configured computing systems, the virtual object in a second virtual environment associated with the second user; (b) providing, by the one or more configured computing systems, information related to the virtual object, the first user, and the second user to one or more sponsors associated with the virtual object; and (c) facilitating, by the one or more configured computing systems, a providing of promotional information associated with at least one of the one or more sponsors to one or more of a group that includes the first user and the second user. The displaying of the virtual object may include displaying the virtual object as a three dimensional object, and the displaying of the first virtual environment may include displaying the first virtual environment as a three dimensional environment.

In certain embodiments, the third computer-implemented method may further include receiving an indication that each of a plurality of other users has selected the virtual object and, based at least in part on the received indication, displaying the virtual object in each of a plurality of virtual environments respectively associated with the plurality of other users and facilitating a providing of the promotional information to each of at least some of the plurality of other users.

In at least some embodiments, the third computer-implemented method may further include providing information related to the object, the first user, and each of at least some of the plurality of users to the one or more sponsors associated with the virtual object.

### BRIEF DESCRIPTION OF THE DRAWINGS

FIG. 1 is a network diagram illustrating an example embodiment of interactions related to a social service aggregation system.

FIGS. 2A-2B illustrate embodiments of a virtual environment that includes a variety of virtual objects representing information provided by a plurality of service providers.

FIG. 3 is a block diagram illustrating an embodiment of a computing system suitable for providing a social service aggregation system.

FIG. 4 is a flow diagram of an example embodiment of a Virtual Object Manager routine.

FIG. 5 is a flow diagram of an example embodiment of a Social Service Information Manager routine.

### DETAILED DESCRIPTION

The present disclosure is generally directed to techniques for aggregating information from multiple network-accessible service providers (such as multiple social networking service providers, or other network-accessible service providers) using virtual objects to represent such information and/or services in a plurality of rendered virtual environments or “rooms.” Each such virtual environment or room may be associated with a particular user of one or more of the multiple service providers. A room associated with a particular user may include, for example, one or more of a house, a garage, a shop, a building, an office, a club, or other internal or external space (any or all of which may be collectively referred to hereinafter as a “room” or “rooms”). Users may be represented in the room by virtual avatars, which may in certain embodiments move or otherwise operate within one or more of the provided virtual environments. In at least some embodiments, the virtual environment and/or its contents (including virtual objects and avatars) may be displayed as two- or three-dimensional. Some or all of the techniques described herein may be performed by automated operations of an embodiment of a Social Network Service Aggregation (“SNSA”) system, such as via a website or client application of the SNSA system, as discussed in greater detail below.

As used herein, a “user” may include individual users of a system or any other entity interacting with the system on behalf of an individual user, including past, future or current users. A sponsor may include any individuals or entities interacting on behalf of a group of affiliated people (e.g., a business or other organization) or other entity. Reference herein to “users” without further designation may include a single person, or in some situations a group of affiliated persons, and may, depending on the context in which the term is used, refer to individual users, entity users, or other individuals and/or entities.

Also as used herein, the term “room” may include one or more virtual environments, each of which may be electronically rendered or otherwise displayed separately or in conjunction with other such virtual environments, and each of which may, unless specifically indicated otherwise, include either or both two-dimensional and three-dimensional representations of such environment.

Also as used herein, the term “avatar” may refer to any electronic representation of a user, a group of users, or other entity or entities, including a sponsor of the SNSA system, an operator of the SNSA system, a social networking service provider or other network-accessible service provider, and may, unless specifically indicated otherwise, include either or both two-dimensional and three-dimensional representations. Also unless specifically indicated otherwise, an “avatar” may be included in discussion of “virtual objects” and may in certain contexts be discussed interchangeably with the user, group of users, or other entities represented by such avatar.

Also as used herein, the term “virtual” when used in relation to one or more objects, avatars, environments, currencies, or other subject may indicate that the subject is digitally, electronically and/or otherwise artificially represented or simulated. “Interactions” with such virtual subjects may include various actions taken with respect to those subjects using various input control devices, depending on the client computing device used to perform such interactions, such as: one or more clicks using a mouse or other pointing device; causing a cursor associated with a mouse or other pointing device to hover over, on or adjacent to the subject; executing one or more taps or other gestures using a touch screen of a client device; etc. Similarly, the term “selecting,” when used in relation to one or more elements of a graphical user interface or other electronic display, may include various such user actions taken with respect to various input control devices.

The “owner” of such virtual objects, avatars, environments, currencies, or other subject may indicate a user, a group of users, or other entity associated with the virtual subject, either alone or in conjunction with other users, groups or entities having similar or identical authorization levels or privileges with respect to the virtual subject. In certain contexts, the “owner” of a virtual subject may indicate an exclusive level of authorization or privilege with respect to the virtual subject that is not shared with another user, group of users, or other entity.

In certain embodiments, the described techniques include computer-implemented methods performed by one or more computing systems that are configured to provide a Social Network Service Aggregation system. For example, the SNSA system may generate and display a room for a particular user associated with the room, such as based on user information, preferences, and/or configuration parameters provided by or otherwise related to the associated user. Accordingly, the associated user may select and/or design all or some aspects of the room and the information displayed therein. Thus, the room may be individually customizable by a user and may contain various virtual items and/or displays pertaining to user information. In addition, although a particular room may be associated with a single user (the “owner” of the room), the owner of the room may in various manners authorize one or more other users to view a room, view some or all of the virtual objects associated with the room, and/or interact with some or all of such virtual objects, such as to view particular information represented by those virtual objects (such as information associated with the room owner with respect to one or more social networks).

Users may use the SNSA system to authenticate interactions with multiple social networking service providers, as well as other service providers, and receive updates from such service providers via a single SNSA user account. Furthermore, in at least some embodiments, in addition to receiving such updates, a user may use the SNSA system to provide new social network information (e.g., status updates, uploaded videos and other media, etc.) to multiple service providers and social networks simultaneously. Such uploads and status updates will appear transparent to other users of those service providers and social networks, but may in certain embodiments provide additional features and functionality to users of the SNSA system. In addition, a user may choose to broadcast or “blast” information received from one service provider to multiple other service providers (such as to quickly display the received information on other social networks or web services). The user may select particular service providers to “blast” from those that the user has integrated with the SNSA system. Similarly, other users that are following a particular user can re-broadcast or “re-blast” the original content to additional users associated with the original recipients. For example, a first user may broadcast content from her first social networking service provider's account to a second, third, and fourth such accounts, all with a single interaction with the SNSA system. Her followers on the second, third, and fourth service providers will receive the broadcasted content and, in turn, those followers may again broadcast the original content (and perhaps include additional content) to all of their own other social networking service providers. Each of the users may separately choose which service providers are to receive such broadcasts.

In some embodiments, the system may provide one or more rewards based on user activities with respect to service providers configured to operate in conjunction with the SNSA system. For example, users may be rewarded in virtual currency for user activities such as registering a new account, accessing a particular quantity of other accounts (such as existing social network service provider accounts), displaying one or more particular virtual objects in a room associated with the user, broadcasting one or more pieces of social networking information to additional accounts associated with the user, extending user invitations, creating and/or populating new rooms, editing avatars or virtual objects, encouraging or succeeding in persuading other users to join the SNSA system, etc. In certain embodiments, the SNSA system may display a salary in the form of virtual currency based on a number of other user accounts the user elects to authorize to interoperate with the SNSA system. In addition, the system may display earned or anticipated rewards and achievements, such as daily, weekly, and monthly achievements for completing online user activities, such as posting information to at least one social networking service provider at least five times in a single week. In at least some embodiments, rewards may be awarded in the form of a virtual currency with which a user can purchase or upgrade virtual objects, rooms, avatars, or services, and achievement of such rewards may be visually indicated in one or more rooms associated with the user, such as by displaying one or more virtual trophy objects associated with those rewards.

In at least some embodiments, a user may interact with the SNSA system to create and/or configure a variety of features related to one or more rooms associated with that user. For example, a room may be associated with configuration parameters that include a room type, lighting, wall color, background color, effects and animations, particular virtual objects to be included within the room, etc. Virtual objects displayed within a user's rooms may, in certain scenarios and embodiments, be further configured, such as using text, hyperlinks, images, and embedded video and/or other media data. For example, a user may add a custom message to certain virtual objects that will be seen if the room's owner or other authorized user performs one or more defined interactions with the virtual object. This may be used to display custom descriptions of the virtual object, indications as to why the user included the virtual object in the associated room, etc. In certain embodiments, one or more visual effects or messages may be displayed to indicate that a virtual object has been added or changed since a particular user last visited the associated room. In addition, various user information (such as name, location, age, education, employment, or other information) may be included or represented by one or more virtual objects displayed within one or more rooms associated with the user. The user information may be depicted by virtual objects in the room, by graphical representations presented on one or more virtual surfaces of the room itself, and/or by graphical representations presented on one or more of the objects displayed within the room.

In addition to rooms and virtual objects, a user may in certain embodiments select and/or configure an avatar associated with the user to represent that user in various contexts within the SNSA system, such as to indicate ownership of one or more rooms, to indicate a particular room currently being viewed by the associated user, to provide one or more graphical animations of the avatar expressing particular reactions to social networking or other information recently viewed by the associated user. In at least some embodiments, the associated user may select from multiple general avatars and customize them in various manners (e.g., hair, clothes, glasses, facial hair, height, weight, accessories and other characteristics). Furthermore, users may in certain embodiments import or utilize particular avatars for a particular purpose or group, such as displaying membership or affiliation with a school, organization, company, etc.

In various embodiments, virtual objects displayed in rooms generated and displayed by the SNSA system may be designated as decorative, functional, or informational, with informational virtual objects representing distinct information and/or services. For example, such virtual objects may include furniture (e.g., couches, bookcases, beds, blinds), fixtures (e.g., windows and lighting fixtures, disco balls, etc.), and decorations (e.g., pictures, posters, rugs, wallpaper, and floor textures or coverings). In particular virtual objects may in various situations and embodiments display associated sponsor branding of the virtual object, such as to visually indicate an associated social networking service provider, other network-accessible service, or media content represented by the virtual object. In addition, virtual objects associated with the same users or distinct users may be dynamically linked in order to transfer or share user information between such virtual objects and/or between users associated with those objects.

In certain embodiments, avatars may be associated with a variety of animations expressing one or more reactions to content associated with particular rooms, virtual objects and/or social networking information. Avatar reaction animations may provide a visual response beyond that which may be conveyed by a “like” button or other simplified interface selection, such as by conveying feelings such as sarcasm, joy, appreciation, happiness, congratulations, etc. For example, the SNSA system may provide one or more user interface elements adjacent to or otherwise associated with one or more incoming pieces of social networking information, allowing a user to immediately provide the user or service provider that originated the information to view an avatar animation corresponding to the reaction that the user experienced upon viewing that information. Such animations may be simple or complex as needed (e.g., an avatar rolling around on the ground laughing, or an avatar exhibiting an “explosive” reaction in which the contents of the room are temporarily damaged, destroyed or misplaced before being restored). In at least some embodiments, only a subset of available reactions or avatar animations may be available to a user by default, with additional reactions and/or avatar animations being offered to the user for purchase, using either real or virtual currency. Additionally, a user may in certain embodiments change or modify an avatar to automatically display particular emotions or reactions based upon one or more triggering events or pieces of content. Users may also be able to modify reactions and emotions expressed by their avatar at various times, such as when updating information related to one or more social networks. In at least one embodiment, the SNSA system may enable the display of one or more user interface elements adjacent to or otherwise associated with a variety of existing social network displays and online Web site displays, such as by use of an API or other programmatic interface provided by the SNSA system.

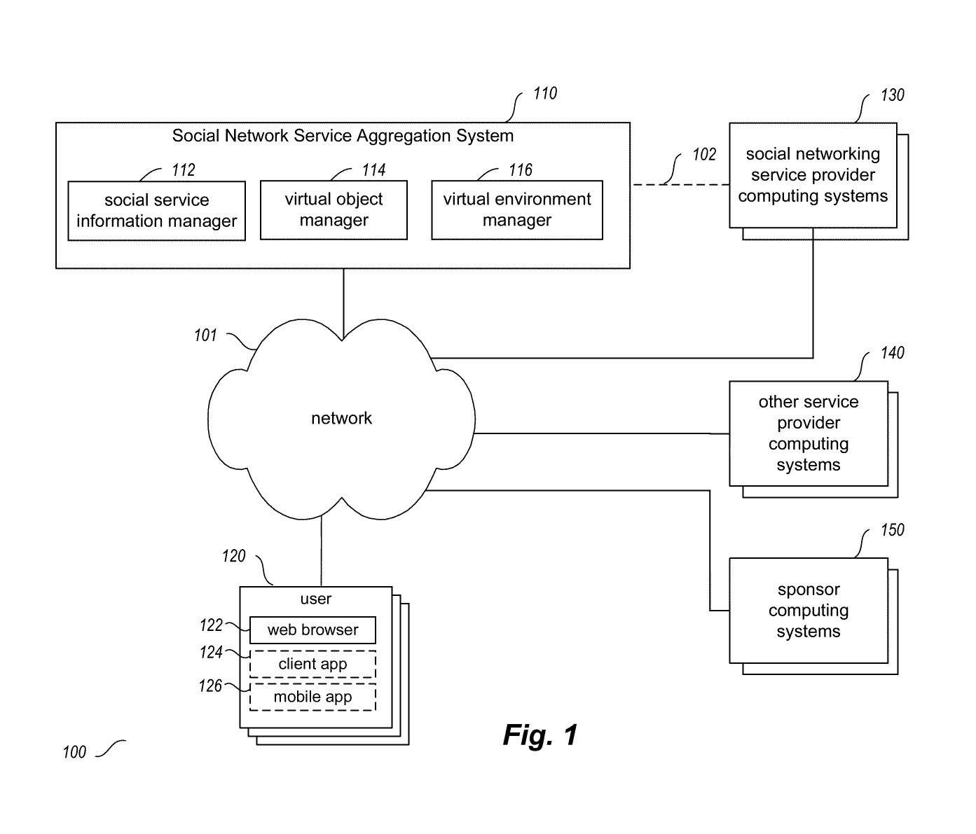

FIG. 1 is a schematic diagram of a networked environment 100 that includes a Social Network Service Aggregation (“SNSA”) system 110 as well as various computing systems associated with one or more social networking service providers, with one or more other service providers, with one or more sponsors, and with one or more users of the social networking service providers, other service providers, and the SNSA system. With respect to at least some embodiments discussed below, the discussion may refer to aggregating types of information associated with some or all of the users, social network service providers, other service providers and sponsors, but it will be appreciated that the same or similar techniques may be applied to other types of information and for other types of uses in other embodiments.

The illustrated example of FIG. 1 includes a number of users 120 that are each interacting at various times with an embodiment of a Social Networking Service Aggregation system 110, either via one or more intervening networks 101 or via the computing systems of one or more social networking service providers 130 and/or other service providers 140.

The interactions of users 120 and other entities with the SNSA system 110 may occur in various ways, such as, in an interactive manner via one or more graphical user interfaces (not shown) provided by the SNSA system 110 to those users and/or other entities via at least some Web pages of a SNSA system Web site provided by one or more Web servers (not shown) associated with the SNSA system. The Web site may be provided in a programmatic manner by one or more client software applications via an Application Program Interface (“API”) provided by the SNSA system 110 that allows computing systems and/or programs to invoke such functionality programmatically, such as using Web services or other network communication protocols. In certain embodiments, social networking service providers or other service providers may integrate various functionality of the SNSA system into their own provided services in such a programmatic manner, such as programmatically adding or configuring rooms, virtual objects, avatars and other content associated with the service provider or other entity.

Similarly, interactions between the SNSA system and computing systems associated with social networking service providers 130, other service providers 140, and sponsors 150 may be performed manually, programmatically, or in some other automated fashion. In the illustrated embodiment, various interactions between users 120 and any or all of the SNSA system 110, social networking service providers 130, other service providers 140 and sponsors 150 may be performed using any or all of a web browser 122, a client application or “app” 124 (such as may be associated with or provided by an operator of the SNSA system 110), or a mobile application 126 (which may similarly be associated with or provided by an operator of the SNSA system) executing on a mobile device of the user (not shown). The web browser 122 may be executing on a fixed or mobile computing device associated with or otherwise available to the user.

In the illustrated embodiment, the SNSA system 110 includes a social service information manager 112, a virtual object manager 114, and a virtual environment manager 116. In addition, the SNSA system may be communicatively coupled to one or more storage components (not shown). In certain embodiments, such storage components may be operated by a third-party data storage service provider, such as may provide various cloud-based storage services; in other embodiments, such storage components may be integrated into the SNSA system directly, and may be operated by an entity that operates the SNSA system.

In situations in which the SNSA system 110 or a service provider provide one or more Web sites, at least some users 120 may perform various interactions at such Web sites. For example, a user may use a client computing device (not shown) to interact with the SNSA system 110 over networks 101, such as to obtain Web pages or other electronic information pages (e.g., HTML-based emails, or other groups of information that are formatted at least in part based on HTML or other formats or markups) from the SNSA system, and to optionally provide various information. Such users 120 may access a Web site provided by the SNSA system to obtain one or more Web pages, such as to view, search for, browse for, and/or provide information related to one or more virtual environments or virtual objects associated with the user or other users, and in certain embodiments other user information (e.g., user account information, preference information, etc.) stored by the SNSA system 110. In certain embodiments, the SNSA system may store various types of user information about such online interactions, including in some cases to record and store information about all interactions and activities performed by the user with respect to the SNSA system.

In this example, the network 101 is a publicly accessible network of linked networks, possibly operated by various distinct parties, such as the Internet, although in other embodiments the network 101 may have other forms. For example, the network 101 may instead be a private network, such as, a corporate or university network that is wholly or partially inaccessible to non-privileged users. In still other embodiments, the network 101 may include both private and public networks, with one or more of the private networks having access to and/or from one or more of the public networks. Furthermore, the network 101 may include various types of wired and/or wireless networks in various situations. In addition, in this illustrated example of FIG. 1, the users 120 may use client computing systems and/or other client devices (not shown) to interact with the SNSA system 110 to obtain various described functionality via the network 101, and in doing so may provide various types of information to the SNSA system 110. Moreover, in certain embodiments, the various users and providers of the networked environment 100 may interact with the SNSA system and/or one or more other users and providers using an optional private or dedicated connection, such as dedicated connection 102. For example, dedicated connection 102 may include one or more VPN (Virtual Private Network) connections.

It will be appreciated that various of the details illustrated with respect to FIG. 1 are provided for illustrative purposes, and may be different in other embodiments. For example, the SNSA system 110 may obtain and store other types of information (whether by storing additional types of information, and/or by not storing at least some of the illustrated types of information), and the information may be stored in various manners (e.g., in a multi-tenant data warehouse or other database, in multiple distinct databases that are each specific to a type of data and/or to a particular retailer, etc.), including to be grouped in other manners than is illustrated. Similarly, the SNSA system 110 may provide other types of functionality than those described (whether by providing additional types of functionality, and/or by not providing at least some of the described types of functionality), and the functionality may be provided via various types of interfaces.

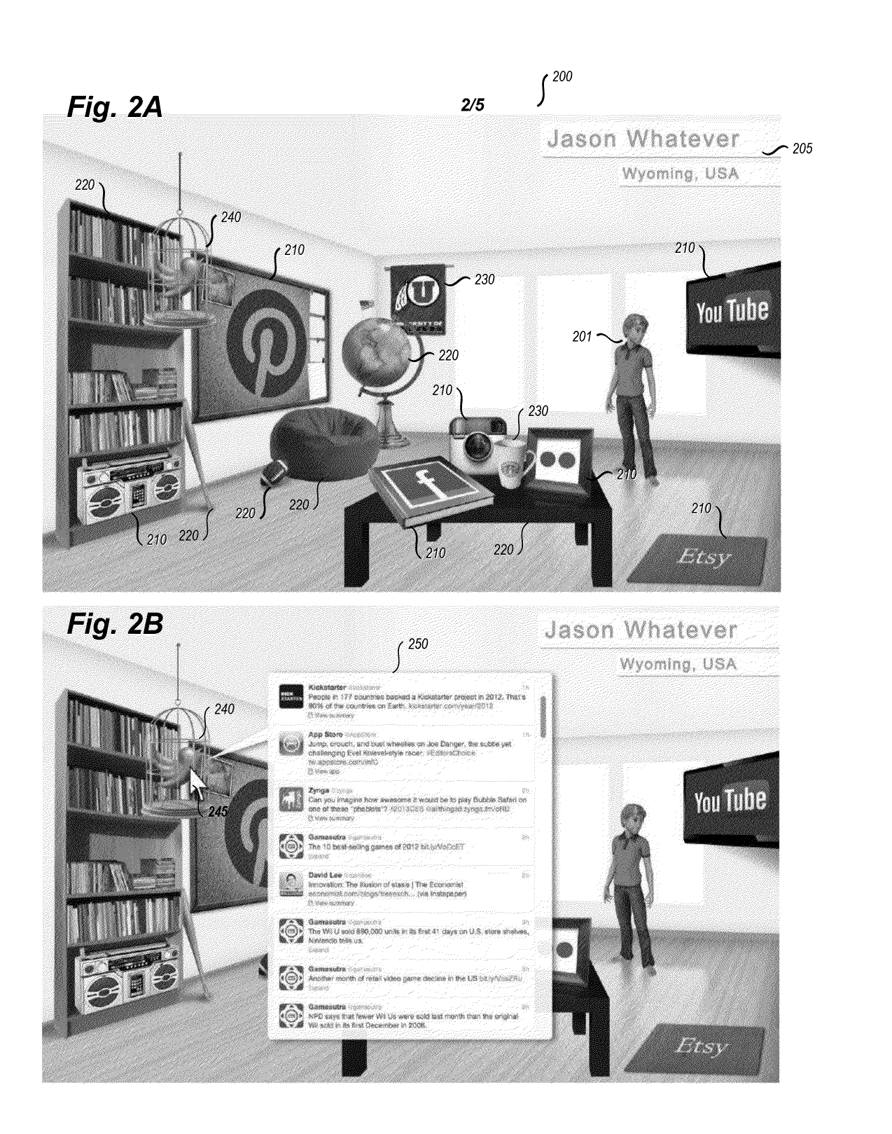

FIGS. 2A-2B illustrate examples of graphical user interface (“GUI”) screens of an exemplary SNSA system for providing and receiving various functionality described herein, in particular with respect to virtual environments and objects related to users, sponsors, social networking service providers and other service providers. It will be appreciated that other embodiments may include more and/or less information, and that various types of illustrated information may be replaced with other information.

FIG. 2A depicts a virtual environment or “room” 200 associated with a user that is represented by an avatar 201. The avatar 201 is currently configured to appear as a human male wearing blue jeans and a short-sleeved shirt, although as described elsewhere herein, the associated user may select from a wide variety of distinct appearances for the avatar. The room as depicted includes owner information 205 indicating a name or alias “Jason Whatever” of the user associated with the room (i.e., the room's “owner”).

In addition to Jason's avatar 201, the room as depicted contains a number of virtual objects 210, each representing a particular social networking service provider. In the depicted example, such virtual objects 210 represent (in no particular order) Facebook, Instagram, Flickr, Etsy, Pinterest, Spotify, and YouTube, and a virtual bluebird object 240 represents Twitter. Each of the virtual objects 210 and 240 include a logo or other indicator generally associated with that social networking service provider, although in certain embodiments the user may configure other virtual objects to represent a service provider even if the virtual object has no visual logo or other indication of such representation. In addition, the room as depicted includes decorative virtual objects 220 (a football, baseball bat, beanbag chair, globe, table, and bookcase), and sponsored virtual objects 230 respectively represent the University of Utah and a popular coffee company each of virtual objects 210 and 230 may enable the associated owner user and visiting users (if so authorized) to interact with the virtual object in order to display and in some cases modify a variety of information associated with the social networking service provider or sponsor respectively associated with that virtual object. In certain embodiments, particular interactions with a virtual object may additionally activate one or more hyperlinks associated with the virtual object, such as may initiate the display of one or more separate or integrated browser windows to retrieve one or more Web pages.

A variety of functionality related to the configuration of particular rooms may be enabled by the SNSA system. For example, in at least some embodiments, a user may be associated with personal and/or public rooms that the user may elect to publish or otherwise provide access for other users in order to share some or all of the user's social networking activity, manage contacts, and display one or more virtual objects. Managing contacts may include adding or deleting contacts, managing room access for particular users, viewing contacts, blocking and unblocking contacts, or similar operations. In certain embodiments, access to rooms designated by the associated user as “personal” may be available only to contacts designated or otherwise selected by the associated user, whereas a published or public room may be viewed by users of the SNSA system without being preauthorized or otherwise designated. In at least some embodiments, in addition to manually providing information for display in one or more rooms associated with the user, the user may import information for display from one or more external databases, Web sites, or service providers. In addition, rooms associated with the same users or distinct users may be dynamically linked in order to transfer or share user information between rooms and/or between users.

In some embodiments, a variety of distinct rooms may be associated with a particular user, and may be organized and/or collectively displayed as if located within areas of a larger virtual environment, such as a house or other structure. Moreover, individual user rooms may be displayed and linked on a platform based upon common user information, such as a common workplace, interest, event type, graduating class, school, sports team, or other organization. Accordingly, external users may view the common house or other structure, and/or may view and interact with such individual rooms in a manner based on the common platform.

In certain embodiments, business and enterprise data may be represented by one or more virtual objects, avatars, and/or virtual environments related to numerous aspects of a particular business, such as products and/or services offered, coupons, promotions, product launches, customer information, and numerous other types of data that may be collected and used by a particular business or industry. As such, a room may be customized for a particular business based upon certain embodiments of a physical business space, product configuration, or other related embodiment. For example, a business may have a room that has similar features to the trade dress of a specific or generic franchise location. Accordingly, the room may have certain colors, furniture, counters, tables, walls, floors, products, and other features that look similar to actual features in a particular store. Furthermore, such room may take the shape and have features that are similar to a trade dress of a particular product, such as a jewelry box, meal box, tool box, or other product that may be offered by the company or relevant to the company, and/or a room may have features that pertain to a service provided by the company, such as education services, personal services, and/or building or technology services.

In at least some embodiments users may create and configure special rooms associated with particular events such as meetings, weddings, bridal showers, parties, etc. Such event rooms may indicate the event date, associated contact info, location (such as by displaying a map and directions), along with virtual objects and pictures to promote the event. In certain scenarios and embodiments, virtual objects stored in an event room may expire on the date of the event and may no longer be available or configurable. In other embodiments and scenarios, such objects may be maintained within the event room for subsequent use and display by particular users, such as one or more collections of images related to the event. Accordingly, business and enterprise users may create rooms for particular internal divisions such as IT, HR, Sales/Marketing, which will enable such users to share links, phone numbers, goals, milestones, news, and even promote star employees for accomplishments. Individual users may control their avatar to perform a variety of functions during such events, such as speaking, messaging, sharing files, viewing objects or files from various views in the conference room, and other events or communication that occurs during business meetings.

In some embodiments, a room may include a virtual window that displays the real-time weather at a physical location of the user or other geographical location selected by the user. In such embodiments, if a user is physically at a location where it is snowing, the window in the virtual room will show it snowing outside (or, if desired, inside) the room. In some embodiments, any user can perform one or more interactions with the virtual window to obtain additional information regarding the weather or representative location, and/or be directed to a sponsor or service provider for the additional weather information. As another example, a room may contain a variety of virtual objects that, when selected, a visiting user may utilize to view images, video, or other content provided by the owner of the room. In some embodiments, a user can create or publish a room at a custom viewpoint of the room. In some embodiments, when an external user is viewing a user room, the external user is allowed the functionality to interactively rotate the room on a particular coordinate. This may allow for a complete view of a room and all the contents therein. In certain embodiments, a user may be able to virtually view other user avatars visiting a particular room, such as by tracking information related to the “visit” in the user room of the external user.

The SNSA system may in certain embodiments provide a timeline view of the various modifications of a particular user room over a period of time. Users with sufficient authorization may elect (such as by selection of one or more user interface elements provided by the SNSA system) to revert a room back to a particular version in time. In such embodiments, the SNSA system may track historical modification and appearance information associated with the room since the room's creation, so that a user may view the room as it existed on a particular date or time.

FIG. 2B depicts the room 200 following a user interaction with the virtual bluebird object 240, as indicated by the pointer 245. As a result of such interaction, the SNSA system initiates the display to the user of information panel 250, which in the depicted embodiment is a scrollable information panel that includes a plurality of recent updates to the user's Twitter feed. The display of this and other additional information may be initiated or controlled in various manners in various embodiments, including based on JavaScript that may be included with a Web page depicting the room 200 and that initiates the display of the information panel 250 under specified criteria (e.g., the user interacting with a SNSA Web site, client application or mobile application in a particular manner, such as initiating the movement of a mouse cursor, finger or other user-controlled indicator to a position associated with a particular region of the depicted virtual environment).

It will be appreciated that the details of the display of the information panel 250 are provided for illustrative purposes only, and that in other embodiments such information may be displayed by the SNSA system in other manners, such as in other locations of the room 200, without overlapping and/or overlaying other information of the room, in a separate frame or other display portion of the current Web page, in a separate pop-up window or other separate display area that is associated with but not part of the Web page, being initiated or controlled in a manner other than using JavaScript (e.g., via HTLM5, cascading style sheets, Adobe Flash, Ajax, Dynamic HTML, by dynamically modifying the content of the Web page, etc.), etc. In addition, it will be appreciated that in addition to the virtual objects displayed within the room 200, various additional user-selectable controls may be provided by the SNSA system to enable the user to modify how and/or where such additional information is displayed. Similarly, the particular types of information that are displayed as part of information panel 250 are simplified here for the sake of understanding, and other types of additional information may be displayed to supplement the display of the current Web page in other embodiments. Furthermore, as will be appreciated, similar or alternative displays of various information associated with other social networking service providers may be initiated by the SNSA system based on other interactions with the virtual objects 210 of FIG. 2A.

A variety of functionality related to the configuration of virtual objects may be enabled by the SNSA system. For example, in certain embodiments users may utilize a mobile application to tag items in a physical or online store (such as by using a UPC code or other product identifier) and thereby display an instance of a corresponding virtual object within one or more rooms associated with the user. In addition, the user may be further enabled to post information about the product, such as a review of the product.

It will be appreciated that the GUIs, display screens and other information presented with respect to FIGS. 2A-2B are included for illustrative purposes, and that such information and/or other information and associated functionality may be presented or otherwise provided in other manners in other embodiments. In addition, it will be appreciated that GUIs and other information presented to users may vary with the type of client device used by the user, such as to present less information and/or functionality via client devices with smaller display screens and/or less ability to present information to or obtain input from the user, such as under control of a mobile application of the SNSA system interface executing on the client device, or otherwise based on information sent to the client device from the SNSA system.

In some embodiments, users can purchase virtual objects representing particular items and services for use or implementation in a particular room associated with that user. For example, if a user desires to have a virtual instance of a real-world item, such as s television or gaming device that the user purchased and owns, the user may virtually purchase a virtual object for display in the user's room that represents the item (such as by displaying a three-dimensional model of the real-world item), whether directly through the SNSA system or indirectly through a sponsor that manufactures and/or sells the item. In certain embodiments, the user may use real or virtual currency to purchase such virtual objects. In addition, a company, through its room or other venue, may provide users with one or more promotional codes that, when redeemed, enable the user to display an instance of the virtual object representing the real-world item within the user's room.

In certain embodiments, users representing entities such as sponsors, corporate entities, or other groups may create, configure, and otherwise be associated with private and/or public rooms. Such rooms may be used to distribute contact information for affiliated users of the entity's private rooms, and may also be used to disseminate promotions and/or promotional information to some or all users of the SNSA system. In some embodiments, a sponsor may obtain information about users that “visit” or view the room of the business user, and in at least some embodiments, the sponsor may obtain information about users that may have selected a virtual object associated with the sponsor for display in a room of the user. For example, a user that enjoys a particular brand of coffee may view one or more rooms associated with the coffee company, select a branded virtual object from the coffee company room, and place an instance of the virtual object within the user's own room, such that other users visiting that room may view the products used, liked, or disliked by the user. In some embodiments, a coupon or redemption code may be associated with the business' item as an incentive for personal users visiting the business room and/or promoting the business' item in a personal room. Accordingly, marketing information and other valuable business information can be obtained through the systems and methods described in the present disclosure regarding interaction between users, rooms, virtual objects, and business products and services.

In addition, a business room or business may receive information about other personal users that clicked or viewed or “hovered over” that businesses user information and/or item contained in a particular personal room. Furthermore, aside from virtual object associated with the sponsor, a user may elect to display a logo or other graphical mark associated with a sponsor on particular items associated with the user, such as clothes, electronics, and other items that may be on or held by the user's avatar. Other users may, in certain situations and embodiments, view and purchase such products or services promoted by an avatar or within a room.

In a similar manner, individual users as well as sponsors and service providers originating a particular virtual object may define and establish various criteria to be satisfied in order for copies or instances of the virtual object to be propagated to other users' rooms. For example, in at least some embodiments the creator of a virtual object may require that a user pay a fee (of real or virtual currency) to display an instance of the virtual object in their own room. In certain situations, the creator of the virtual object may require that such user provide additional information in order to display an instance of the virtual object, such as by completing a survey, providing contact information such as an email address or telephone number, etc.

As another example of extended functionality provided by certain embodiments of the described SNSA system, a virtual object may be configured for display in a user's room that can facilitate dating or other social interactions between users. Such an object may be displayed or hidden depending on various criteria and preferences defined by the user, and as with other virtual objects in a user's room, may be configured to remain invisible to users other than the owner that visit the room. The virtual object may be configured to display various information useful for such social interactions—potential matches, most recent messages, etc. In certain embodiments, the object may be configured in a manner that facilitates communication from other users at no charge, but would require a small fee from the user to enable the user to reply to such communications. In certain embodiments, for security purposes the SNSA system may perform additional measures to ensure identity verification and/or anonymity for those users engaging in social interactions using virtual objects in this manner.

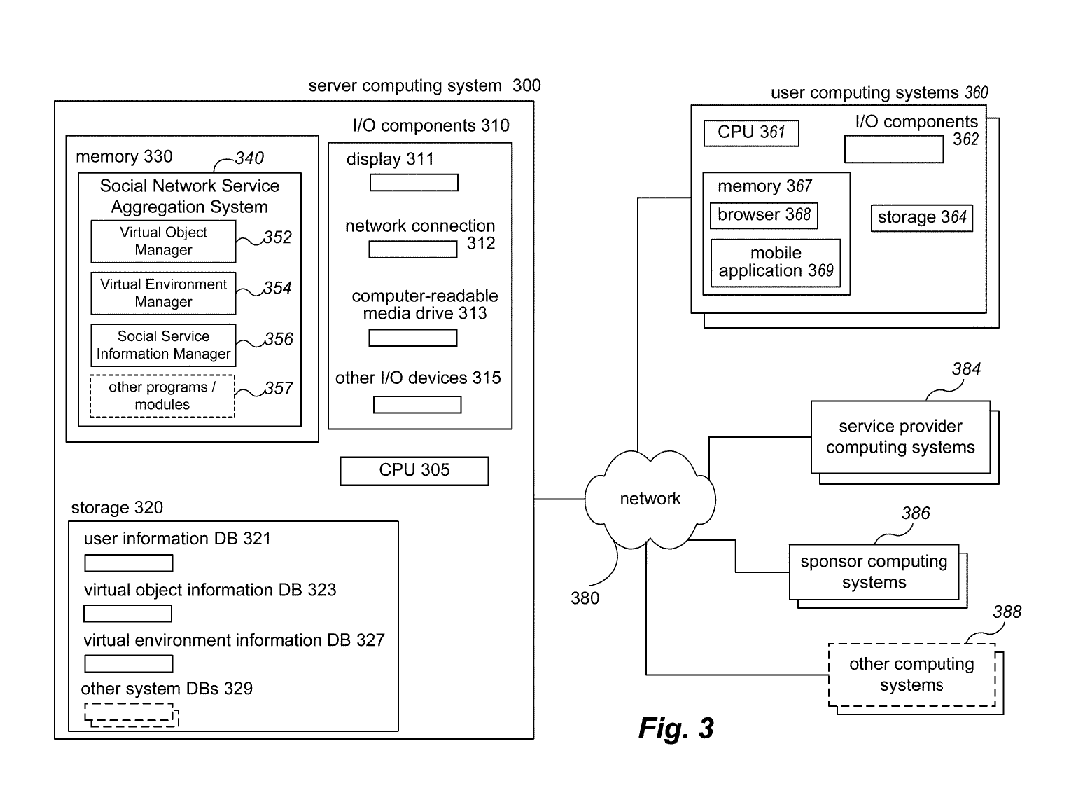

FIG. 3 is a block diagram illustrating an embodiment of a server computing system 300 that is suitable for performing at least some of the described techniques, such as by executing an embodiment of a Social Network Service Aggregation (SNSA) system. The computing system 300 includes one or more central processing units (“CPU”) or other processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.). The server computing system 300 and SNSA system 340 may communicate with other computing systems via one or more networks 380 (e.g., the Internet, one or more cellular telephone networks, etc.), such as user computing systems 360, service provider computing systems 384, sponsor computing systems 386, and other computing systems 388. Some or all of the computing systems may similarly include some or all of the types of components illustrated for server computing system 300 (e.g., to have a SNSA system client application 369 executing in memory 367 of a user computing system 360 in a manner analogous to SNSA system 340 executing in memory 330).

In the illustrated embodiment, an embodiment of the SNSA system 340 executes in memory 330 in order to perform at least some of the described techniques, such as by using the processor(s) 305 to execute software instructions of the system 340 in a manner that configures the processor(s) 305 and computing system 300 to perform automated operations that implement those described techniques. As part of such automated operations, the SNSA system 340 and/or other optional programs or modules 357 executing in memory 330 may store and/or retrieve various types of data, including in the example database data structures of storage 320. In this example, the data used may include various types of user information in database (“DB”) 321, various types of virtual object information in DB 323, various types of virtual environment information in DB 327, and/or various types of other information in DB 329.

It will be appreciated that computing system 300 and computing systems 360, 384, 386 and 388 are merely illustrative and are not intended to limit the scope of the present invention. The systems and/or devices may instead each include multiple interacting computing systems or devices, and may be connected to other devices that are not specifically illustrated, including through one or more networks such as the Internet, via the Web, or via private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, digital music player devices, handheld gaming devices, PDAs, wireless phones, pagers, electronic organizers, Internet appliances, television-based systems (e.g., using set-top boxes and/or personal/digital video recorders), and various other consumer products that include appropriate communication capabilities. In addition, the functionality provided by the illustrated SNSA system 340 may in some embodiments be distributed in various modules other than those specific modules depicted. Similarly, in some embodiments, some of the functionality of the SNSA system 340 may not be provided and/or other additional functionality may be available.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., the SNSA system 340 and/or SNSA client software executing on any or all of computing systems 360, 384, 386 and 388) and/or data structures, such as by execution of software instructions of the one or more software programs and/or by storage of such software instructions and/or data structures. Furthermore, in some embodiments, some or all of the systems and/or modules may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a non-transitory computer-readable storage medium, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

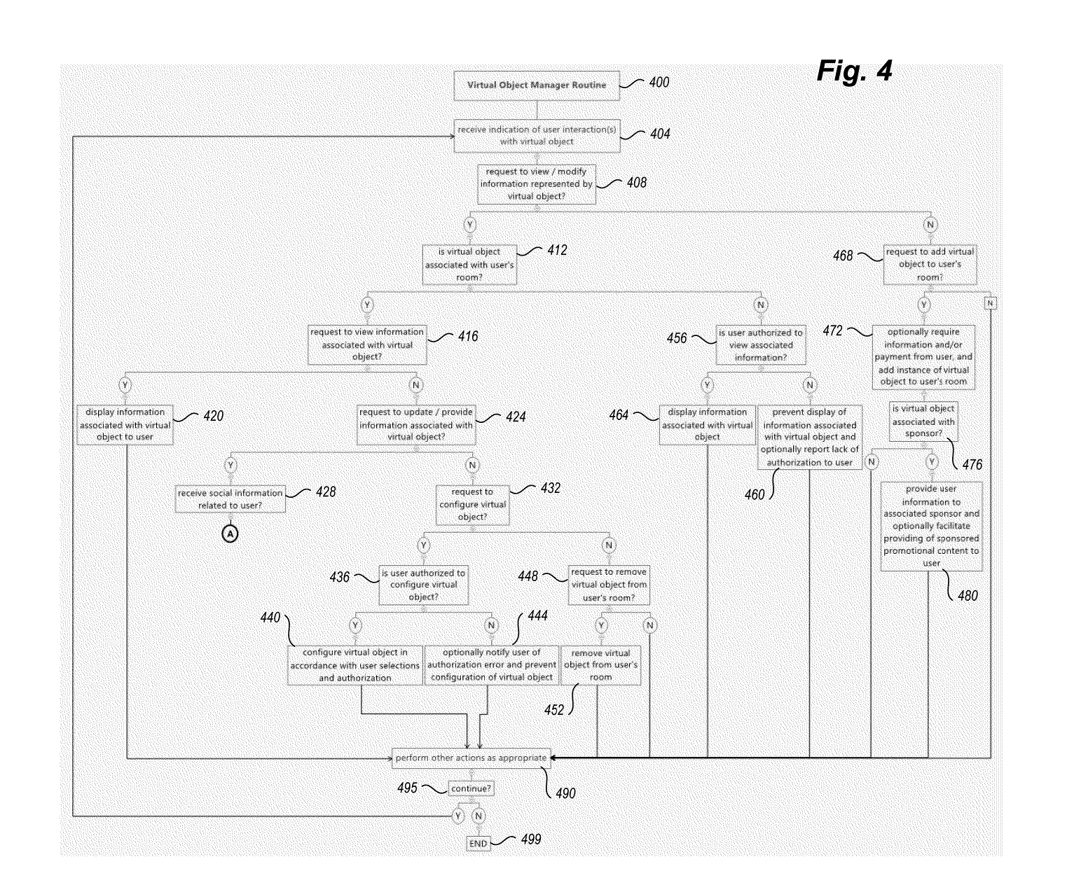

FIG. 4 is a flow diagram of an example embodiment of a Virtual Object Manager routine 400, such as may be performed by virtual object manager 114 of the networked environment 100 depicted by FIG. 1, and/or the virtual object manager 352 of the SNSA system 340 executed by the server computing system 300 of FIG. 3. The routine begins at block 404, in which the routine receives an indication from a user of one or more interactions by that user with a virtual object. For example, in certain situations, the virtual object may be displayed in a virtual environment associated with the user or another user of the SNSA system, or may simply be indicated as available for use within such a virtual environment, such as in one or more lists or other interface elements displayed to the user. The routine continues to block 408 to determine whether the user interactions indicate a request to view or modify information represented by the virtual object (or possibly to modify or configure the virtual object itself). If so, the routine proceeds to block 412 to determine whether the virtual object is already associated with one or more virtual environments (rooms) of the user.

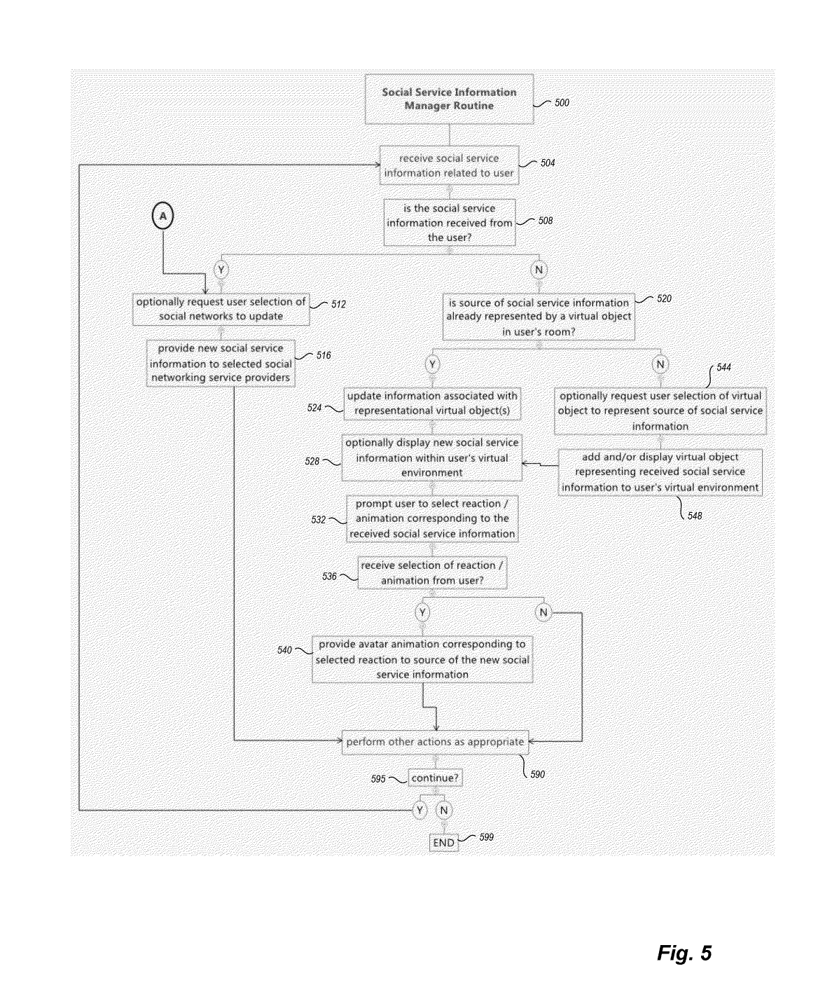

If in block 412 it is determined that the virtual object is associated with a room of the user, the routine proceeds to block 416 to determine whether the indicated request is to view the information represented by the virtual object. If so, the routine proceeds to block 420 and displays to the user the information represented by the virtual object, such as various social networking information represented by the virtual object. Otherwise, the routine proceeds to block 424 to determine whether the request is to update the information associated with the virtual object. If so, the routine proceeds to block 428 and prompts the user for updated social service information related to the user, such as various status update information. Upon receiving such updated information, the routine may pass the information to block 512 of the Social Service Information Manager routine as depicted by FIG. 5.

If in block 424 it is determined that the user is not requesting to update the information represented by the virtual object, the routine proceeds to block 432 to determine whether the request is to configure the virtual object. If so, the routine proceeds to block 436 to determine whether the user is authorized to configure the virtual object. For example, if the virtual object has been created or provided by another user of the SNSA system, or created or provided by one or more sponsors, a user may be unauthorized to configure the virtual object even if the virtual object is displayed within a room of the user. If it is determined that the user is authorized to configure the virtual object, the routine proceeds to block 440 and allows the user to configure the virtual object in accordance with the user's selections and level of authorization with respect to the virtual object. For example, as noted elsewhere, if the virtual object has been created or provided by another user or a sponsor, the manner in which the user may configure the virtual object may be limited, or may result in one or more fees being charged to the user for such configuration, either in “real” or virtual currency. If it is determined in block 436 that the user is not authorized to configure the virtual object, or that the user is unwilling or unable to satisfy various criteria for configuring the virtual object (such as being unwilling or unable to pay one or more fees associated with such configuration), the routine proceeds to block 444, in which the user is optionally notified of an authorization error and prevented from configuring the virtual object.

If in block 432 it was determined that the indicated request was not to configure the virtual object, the routine proceeds to block 448 to determine whether the indicated request is to remove the virtual object from the user's room. If so, the routine proceeds to block 452 and removes the virtual object from the user's room. In certain situations, user preferences, authorization levels, or other information associated with the particular instance of the virtual object being removed may be maintained or otherwise stored by the SNSA system, such as to enable the user to reinstate the virtual object in one or more of the user's rooms at a later time. In other embodiments and situations, removal of the virtual object may result in the deletion or reset of all configuration options previously received from the user with respect to that virtual object.

If it was determined in block 412 that the virtual object is not associated with a room of the interacting user, the routine proceeds to block 456 to determine whether the user is authorized to view the information represented by the virtual object. For example, a visiting user may be authorized to view a particular room associated with another user and yet unauthorized to view information associated with or represented by a particular virtual object with which the visiting user has attempted to interact. If the user is authorized to view the information represented by the virtual object, the routine proceeds to block 464 and displays the information represented by the virtual object to the interacting user. If the user is not authorized to view the associated information, the routine proceeds to block 460, preventing the display of the associated information and optionally reporting the lack of authorization to the room owner, the interacting user, or both.

If it was determined in block 408 that the indicated request is not to view or modify the information represented by the virtual object, the routine proceeds to block 468 to determine whether the indicated request is to add an instance of the virtual object to a room associated with the interacting user. If so, the routine proceeds to block 472 and adds an instance of the virtual object to the user's room. In certain situations and embodiments, the user may be prompted to specify a particular room to which the virtual object is to be added—for example, if the user is associated with multiple rooms. Optionally, the SNSA system may require additional information or the payment of one or more fees from the interacting user prior to providing an instance of the virtual object to the user's room. For example, if the virtual object has been created by or otherwise provided by another user or sponsor, that other user or sponsor may have associated the virtual object with one or more criteria to be satisfied before an instance of the virtual object may be propagated to another room or user. In certain scenarios and embodiments, and as described elsewhere herein, such criteria may include the providing of various information by the requesting user, the payment of one or more fees in “real” or virtual currency, etc. The routine then proceeds to block 476 to determine whether the virtual object is associated with a sponsor. If so, the routine proceeds to block 480 and provides certain defined user information to the associated sponsor. Optionally, the routine may also facilitate the providing of sponsored promotional content to the user requesting the addition of the virtual object.

After blocks 420, 440, 444, 452, 464, 460, 480, or if it was determined in block 448 that the indicated request was not to remove the virtual object or determined in block 476 that the virtual object is not associated with a sponsor, the routine proceeds to block 490 to optionally perform any other actions as appropriate, such as any housekeeping tasks. In block 495, the routine then determines whether to continue. If so, the routine returns to block 404, and if not continues to step 499 and ends.

FIG. 5 is a flow diagram of an example embodiment of a Social Service Information Manager routine 500, such as may be performed by social service information manager 112 of the networked environment 100 depicted by FIG. 1, and/or the social service information manager 356 of the SNSA system 340 executed by the server computing system 300 of FIG. 3. The routine starts in block 504, in which the routine receives social service information related to a user. The routine then proceeds to block 508 to determine whether the received social service information has been received from the user (as opposed to being received via one or more social networking or other service providers), such as if the user wishes to update or otherwise provide social service information to one or more social networks. If it is determined that the social service information has been received from the user, the routine proceeds to block 512 to optionally request that the user select one or more particular social networks to which the received social service information is to be provided. The routine then proceeds to block 516, and provides the new social service information to one or more social networking service providers, such as those corresponding to the social networks selected by the user or those configured as the default providers for new social service information from the user.

If it was determined in block 508 that the new social service information was not received from the user, the routine proceeds to block 520 to determine whether the source of the new social service information is already represented by one or more virtual objects in a virtual environment associated with the user (i.e., the user's “room”). If so, the routine proceeds to block 524, updates the information represented by the corresponding virtual object, and in block 528 optionally displays the new social service information within the user's room. The routine then proceeds to block 532 and, subject to preferences previously provided by the user, optionally prompts the user to select a reaction or animation corresponding to the newly received social service information. In block 536, the routine determines whether the user has selected such a reaction or animation (such as within a predefined period of time after being prompted). If so, the routine proceeds to block 540 and provides an avatar animation corresponding to the selected reaction to the originating social network and/or user from which the new social service information was received.

If it was determined in block 520 that the source of the new social service information is not already represented by one or more virtual objects in the user's room, the routine proceeds to block 544 to optionally request that the user select a virtual object to represent the new source of the received social service information. In certain situations, system defaults or preferences previously provided by the user may instead allow the routine to automatically determine an appropriate virtual object to display to represent the new source of the received social service information. In either case, the routine proceeds to block 548, in which the virtual object representing the received social service information is added to and/or displayed within one or more rooms in the user's associated virtual environment. The routine then proceeds to block 528 and continue from there as described above.

After blocks 516 or 540, or if it was determined in block 536 that no selection of a reaction or animation was timely provided by the user, the routine proceeds to block 590 to optionally perform any other actions as appropriate, such as any housekeeping tasks. In block 595, the routine then determines whether to continue. If so, the routine returns to block 504, and if not continues to step 599 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, in other embodiments the operations may be performed in other orders and in other manners. Any data structures discussed above may also be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Moreover, aspects and features of the various embodiments of the techniques, features, functionality and related methods described above can be combined to provide further embodiments. In addition, U.S. Provisional Patent Application Nos. 61/756,457, filed Jan. 24, 2013, and 61/898,216, filed Oct. 31, 2013, are incorporated by reference for all purposes and aspects of the invention can be modified, if necessary, to employ features, systems, and concepts disclosed in the applications to provide yet further embodiments. Accordingly, the invention is not limited except as by corresponding claims and the elements recited by those claims. In addition, while certain aspects of the invention may be presented in certain claim forms at certain times, the inventors contemplate the various aspects of the invention in any available claim form. For example, while only some aspects of the invention may be recited as being embodied in a computer-readable medium at particular times, other aspects may likewise be so embodied.

What is claimed is:

1. A computer-implemented method, comprising:
receiving, by one or more computing systems configured to provide a social network service aggregation system, first social network data relating to a first user from a first social network service;
receiving, by the one or more configured computing systems, second social network data relating to the first user from a second social network service;
displaying, by the one or more configured computing systems, a first virtual object representative of the first social network data within a virtual environment associated with the first user; and
displaying, by the one or more configured computing systems and concurrently with the displaying of the first virtual object, a second virtual object representative of the second social network data within the virtual environment associated with the first user.

2. The computer-implemented method of claim 1 wherein the one or more configured computing systems are associated with the first user, and wherein the receiving of the first social network data and second social network data is performed locally with respect to the first user.

3. The computer-implemented method of claim 1 wherein, for at least one of the first virtual object and second virtual object, displaying the virtual object includes displaying the virtual object as a three-dimensional virtual object.

4. The computer-implemented method of claim 1 wherein the virtual environment associated with the first user is a three-dimensional environment.

5. The computer-implemented method of claim 1 wherein the displaying of the first and second virtual objects includes displaying the virtual objects to a distinct second user, and wherein the method further comprises receiving an indication of a request from the distinct second user to access at least some of the first social network data, the indicated request being based at least in part on one or more interactions of the distinct second user with the first virtual object.

6. The computer-implemented method of claim 5 further comprising displaying, based at least in part on the received request from the distinct second user, at least a portion of the first social network data to the distinct second user.

7. The computer-implemented method of claim 1 further comprising receiving an indication of a request from the first user to access at least some of the first social network data, the indicated request being based at least in part on one or more interactions of the first user with the first virtual object, and based at least in part on the receiving of the indicated request, displaying to the first user at least a portion of the first social network data.

8. The computer-implemented method of claim 1, further comprising:
receiving an indication of user-generated data from the first user; and
based at least in part on the indicated user-generated data, providing the indicated user-generated data to (a) one or more remote servers associated with the first social network service and (b) one or more distinct other remote servers associated with the second social network service.

9. The computer-implemented method of claim 8 further comprising receiving from the first user an indication that the first user has selected the first social network service and the second social network service, wherein the providing of the user-generated data is further based in part on receiving the indicated selections from the first user.

10. The computer-implemented method of claim 8 wherein the user-generated data includes at least one of a group of information provided by the first user that includes text, video, graphics, and images.

11. The computer-implemented method of claim 8, further comprising sending the user-generated data to one or more of a plurality of other users of the social network service aggregation system, the sending of the user-generated data being based at least in part on receiving an indication that a distinct second user has selected to send the user-generated data to the one or more other users.

12. The computer-implemented method of claim 1 comprising providing one or more rewards to the first user, the providing of the one or more rewards including:
receiving activity information indicative of one or more user activities of the user; and
providing the one or more rewards to the first user based at least in part on the received activity information.

13. The computer-implemented method of claim 12 wherein the receiving of the first social network data is based at least in part on an authorization by the first user for the social network service aggregation system to access a profile of the first user within the first social network service, and wherein the activity information specifies a quantity of other users associated with the profile of the first user within the first social network service.

14. The computer-implemented method of claim 12 wherein the activity information specifies one or more of a group that includes a length of user session time, a frequency of user log in sessions, and a quantity of social events.

15. The computer-implemented method of claim 12 wherein the provided rewards include one or more units of a virtual currency.

16. The computer-implemented method of claim 15, further comprising receiving a request from the first user to exchange one or more units of the virtual currency for one or more virtual objects and, based at least in part on receiving the request, associating the one or more virtual objects with the virtual environment of the first user.

17. The computer-implemented method of claim 1 wherein the displaying of the first virtual object includes displaying the first virtual object to a distinct second user, and wherein the method further comprises:
receiving an indication of one or more interactions of the second user with the first virtual object; and
based at least in part on the one or more interactions of the second user, associating a copy of the first virtual object with a distinct second virtual environment associated with the second user, wherein the associating of the copy of the first virtual object includes displaying the copy of the first virtual object within the distinct second virtual environment.

18. The computer-implemented method of claim 17 wherein the one or more interactions of the second user include requesting a copy of the first virtual object in exchange for one or more units of a virtual currency.

19. The computer-implemented method of claim 17, further comprising maintaining an association between the first virtual object and the copy of the first virtual object, such that future changes to the first virtual object are propagated to the copy of the first virtual object.

20. A computer-implemented method, comprising:
displaying to a first user, by one or more configured computing systems, social networking information from a second user, the displaying of the social networking information being performed concurrently with displaying to the first user a virtual environment associated with the first user;
providing, by the one or more configured computing systems, one or more user-selectable interface elements to the first user, each of the user-selectable interface elements corresponding to a distinct reaction of a graphical avatar;
receiving, by the one or more configured computing systems, an indication of a selection by the first user of at least one of the one or more user-selectable interface elements; and
displaying to the second user, by the one or more configured computing systems, an avatar animation that includes the graphical avatar expressing the distinct reaction corresponding to the at least one interface element selected by the first user.

21. The computer-implemented method of claim 20, further comprising providing unique origination information to the second user corresponding to the avatar animation, the unique origination information including a web service link for the second user to view the avatar animation.

22. The computer-implemented method of claim 20, further comprising providing an indication to the second user that the avatar animation reflects an emotional response of the first user to the social networking information from the second user.

23. A computer-implemented method, comprising:
displaying, by one or more configured computing systems, a first virtual environment associated with a first user on a computing system of a second user, the first virtual environment including a virtual object selected by the first user for display in the first virtual environment; and
based at least in part on a selection by the second user of the virtual object in the first virtual environment:
displaying, by the one or more configured computing systems, the virtual object in a second virtual environment associated with the second user;
providing, by the one or more configured computing systems, information related to the virtual object, the first user, and the second user to one or more sponsors associated with the virtual object; and
facilitating, by the one or more configured computing systems, a providing of promotional information associated with at least one of the one or more sponsors to one or more of a group that includes the first user and the second user.

24. The computer-implemented method of claim 23 wherein the displaying of the virtual object includes displaying the virtual object as a three dimensional object, and wherein the displaying of the first virtual environment includes displaying the first virtual environment as a three dimensional environment.

25. The computer-implemented method of claim 23, further comprising receiving an indication that each of a plurality of other users has selected the virtual object and, based at least in part on the received indication, displaying the virtual object in each of a plurality of virtual environments respectively associated with the plurality of other users and facilitating a providing of the promotional information to each of at least some of the plurality of other users.

26. The computer-implemented method of claim 25, further comprising providing information related to the object, the first user, and each of at least some of the plurality of users to the one or more sponsors associated with the virtual object.
